(19) United States
(12) Patent Application Publication
(10) Pub. No.: US 2026/0121436 A1
(43) Pub. Date: Apr. 30, 2026

(54) CONTROL CIRCUIT SUITABLE FOR POWER SUPPLIES WITH FREELY SWITCHABLE VOLTAGE

(71) Applicant: SHENZHEN ORIENTAL WILLING NEW ENERGY CO., LTD, Shenzhen (CN)

(72) Inventor: Kunli Wang, Shenzhen (CN)

(21) Appl. No.: 18/974,499

(22) Filed: Dec. 9, 2024

(30) Foreign Application Priority Data
Oct. 28, 2024 (CN) 202411517397.1

(51) Int. Cl. H02J 7/00

(52) U.S. Cl. CPC H02J 7/92; H02J 7/60; H02J 7/70; H02J 7/80; H02J 7/855

(57) ABSTRACT

Provided is a control circuit suitable for power supplies with freely switchable voltages, comprising a first control circuit for freely switching the power supply voltage, a second and a third control circuits electrically connected to the first control circuit. It enables the power supply voltage to be switchably outputted at different voltage levels and realizes the conversion and protection functions of battery voltage. In other words, the present solution can meet the voltage requirements of different devices. Through precise battery management, it ensures that the battery operates safely and efficiently, thereby extending the battery's service life. In terms of user-friendliness: it provides a simple and easy-to-use voltage switching mechanism, enabling users to effortlessly select the required voltage output according to their needs. By adopting rechargeable lithium batteries to replace traditional dry batteries, it reduces the environmental pollution caused by discarded batteries while achieving energy conservation and reuse.

### TECHNICAL FIELD

This application belongs to the technical field of power supply voltage output control circuits, specifically relating to a control circuit suitable for power supplies with freely switchable voltage.

### BACKGROUND

Currently, when batteries are in use, they cannot achieve switchable power supply voltage output for different voltages, nor can they realize battery voltage conversion and protection functions. In other words, existing batteries cannot achieve dual-voltage output.

Furthermore, there are challenges in efficiently achieving voltage conversion between dual voltages to reduce energy loss and improve battery usage efficiency. Additionally, battery management faces difficulties in accurately monitoring the charging and discharging states of batteries, as well as implementing overcharge/over-discharge protection to extend battery lifespan and enhance safety. Another issue is how to implement a user-friendly voltage switching mechanism that allows users to conveniently select the required voltage output based on their needs. These are all drawbacks present in existing batteries.

Therefore, in response to the technical issues and deficiencies mentioned above, which include the inability to achieve switchable power supply voltage output for different voltages, the lack of battery voltage conversion and protection functions, and the drawbacks of existing batteries, there is an urgent need to design and develop a control circuit suitable for power supplies with freely switchable voltage.

### SUMMARY

To overcome the deficiencies and difficulties of the existing technology mentioned above, the purpose of this application is to provide a control circuit suitable for power supplies with freely switchable voltages, so as to achieve switchable output of different voltages from the power supply and realize battery voltage conversion and protection functions.

The purpose of this application is to provide a control circuit suitable for power supplies with freely switchable voltages.

The purpose of this application is achieved as follows.

The control circuit includes a first control circuit for freely switching the power supply voltage, a second control circuit and a third control circuit electrically connected to the first control circuit; wherein the second control circuit is a charging circuit, the third control circuit is a protection circuit.

The first control circuit is provided with a toggle switch for controlling real-time switching of the power supply voltage output; the third pin of the toggle switch is connected to the first end of a ninth resistor, the first terminal of a first transistor, and the second control circuit, the second terminal of the ninth resistor is connected to the output terminal and the second terminal of the first transistor; the third terminal of the first transistor is connected to the output terminal and the third terminal of a second transistor.

The first pin of the toggle switch is connected to the first terminal of a tenth resistor and the first terminal of the second transistor, the second terminal of the tenth resistor is connected to the input terminal and the second terminal of the second transistor.

Furthermore, both the first transistor and the second transistor are XGC15P16AL.

Furthermore, the second control circuit is provided with a first control chip.

The first pin of the first control chip is connected to the first terminal of a fifth resistor; the second terminal of the fifth resistor is grounded; the second pin of the first control chip is connected to the cathode of a first light-emitting diode; the anode of the first light-emitting diode is connected to the input terminal.

The third pin of the first control chip is connected to the first terminal of a sixth resistor; the second terminal of the sixth resistor and the fourth pin of the first control chip are commonly grounded.

The sixth pin of the first control chip is connected to the first terminal of a first inductor; the second terminal of the first inductor is connected to the output terminal, the first terminal of a second capacitor, and the eighth pin of the first control chip; the second terminal of the second capacitor is grounded.

The seventh pin of the first control chip is connected to the input terminal and the first terminal of a first capacitor; the second terminal of the first capacitor is grounded.

Furthermore, the first control chip is XGC3F01.

Furthermore, the third control circuit is provided with a fourth control chip.

The first pin of the fourth control chip is connected to the second pin of the fourth control chip and the first terminal of a sixth capacitor; the second terminal of the sixth capacitor is connected to the third pin of the fourth control chip and the first terminal of a fourteenth resistor, respectively.

The fourth pin of the fourth control chip is connected to the first terminal of a twelfth resistor; the second terminal of the twelfth resistor, the fifth pin of the fourth control chip, and the sixth pin of the fourth control chip are commonly grounded.

Furthermore, the fourth control chip is XGC3F08B.

Furthermore, the control circuit is also provided with an interface unit.

The third pin of the interface unit is connected to the first terminal of a first resistor; the fourth pin of the interface unit is connected to the first terminal of a third resistor; the second terminal of the first resistor, the second terminal of the third resistor, the first pin of the interface unit, and the sixth pin of the interface unit are commonly grounded.

Furthermore, the model of the interface unit is TYPEC6P-LT1.

The present application provides a control circuit suitable for power supplies with freely switchable voltages, comprising a first control circuit for freely switching the power supply voltage, a second control circuit and a third control circuit electrically connected to the first control circuit; wherein the second control circuit serves as a charging circuit; the third control circuit serves as a protection circuit; the first control circuit is provided with a toggle switch for controlling real-time switching of power supply voltage output; the third pin of the toggle switch is connected to the first terminal of a ninth resistor, the first terminal of a first transistor, and the second control circuit, respectively; the second terminal of the ninth resistor is connected to the output terminal and the second terminal of the first transistor, respectively; the third terminal of the first transistor is connected to the output terminal and the third terminal of a second transistor, respectively; the first pin of the toggle switch is connected to the first terminal of a tenth resistor and the first terminal of the second transistor, respectively, the second terminal of the tenth resistor is connected to the input terminal and the second terminal of the second transistor, respectively, thereby enabling the power supply voltage to be switched to output different voltages and realizing battery voltage conversion and protection functions.

In other words, through the solution of the present application, rapid and efficient voltage conversion between power supply voltages can be achieved to meet the voltage requirements of different devices. In terms of battery management optimization: precise battery management ensures that the battery operates safely and efficiently, thereby extending its service life. In terms of user-friendliness: a simple and easy-to-use voltage switching mechanism is provided, allowing users to easily select the required voltage output as needed.

Meanwhile, in terms of environmental protection and energy saving: by adopting rechargeable lithium batteries to replace traditional dry batteries, pollution to the environment from discarded batteries is reduced, while energy conservation and reuse are achieved.

### BRIEF DESCRIPTION OF THE DRAWINGS

In order to more clearly illustrate the technical solutions in the embodiments of the present application, a brief introduction to the drawings required for describing the embodiments will be provided below. It is evident that the drawings described below are merely some embodiments of the present application. For those skilled in the art, other drawings can be obtained based on these drawings without exercising creative efforts.

FIG. 1 is a schematic diagram of the principle framework of a control circuit suitable for power supplies with freely switchable voltages according to an embodiment of the present application.

FIG. 2 is a schematic diagram of the first control circuit of an embodiment of a control circuit suitable for power supplies with freely switchable voltages according to the present application.

FIG. 3 is a schematic diagram of the second control circuit of an embodiment of a control circuit suitable for power supplies with freely switchable voltages according to the present application.

FIG. 4 is a schematic diagram of the third control circuit of an embodiment of a control circuit suitable for power supplies with freely switchable voltages according to the present application.

FIG. 5 is a schematic diagram of the interface unit circuit of an embodiment of a control circuit suitable for power supplies with freely switchable voltages according to the present application.

FIG. 6 is a front view of the first control circuit of an embodiment of a control circuit suitable for power supplies with freely switchable voltages according to the present application.

FIG. 7 is a rear view of the first control circuit of an embodiment of a control circuit suitable for power supplies with freely switchable voltages according to the present application.

FIG. 8 is a front view of the printed circuit board of the second control circuit of an embodiment of a control circuit suitable for power supplies with freely switchable voltages according to the present application.

FIG. 9 is a rear view of the printed circuit board of the second control circuit of an embodiment of a control circuit suitable for power supplies with freely switchable voltages according to the present application.

Reference numbers: R1—First resistor; R3—Third resistor; R5—Fifth resistor; R9—Ninth resistor; R10—Tenth resistor; R14—Fourteenth resistor; R12—Twelfth resistor; Q1—First transistor; Q2—Second transistor; U1—First control chip; D1—First light-emitting diode; R6—Sixth resistor; L1—First inductor; C2—Second capacitor; C1—First capacitor; U4—Fourth control chip; C6—Sixth capacitor.

### DETAILED DESCRIPTION

To better understand the objectives, technical solutions, and advantages of the present application, further explanations are provided below in conjunction with the accompanying drawings and specific embodiments. Those skilled in the art can easily appreciate other advantages and functionalities of the present application based on the disclosed contents of this specification.

The present application can also be implemented or applied through other different specific examples. Various modifications and changes can be made to the details in this specification based on different perspectives and applications without departing from the spirit of the present application.

It should be noted that if directional indications (such as up, down, left, right, front, rear, etc.) are involved in the embodiments of the present application, these directional indications are only used to explain the relative positional relationships and movement situations between various components under a specific orientation (as shown in the drawings). If the specific orientation changes, the directional indications should change accordingly.

Additionally, if descriptions involving “first,” “second,” and so on are present in the embodiments of the present application, these descriptions are for illustrative purposes only and should not be understood as indicating or implying their relative importance or implicitly specifying the number of indicated technical features. Thus, features defined with “first,” “second,” and so on can explicitly or implicitly include at least one of the features.

Furthermore, the technical solutions between various embodiments can be combined with each other, but this must be based on the capability of those skilled in the art to achieve such combinations. When the combination of technical solutions results in contradictions or becomes unachievable, it should be considered that such a combination does not exist and is not within the scope of protection claimed by the present application.

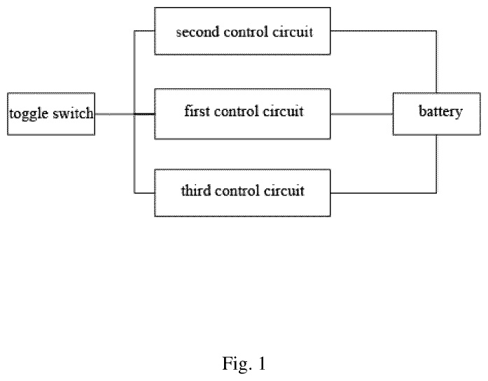

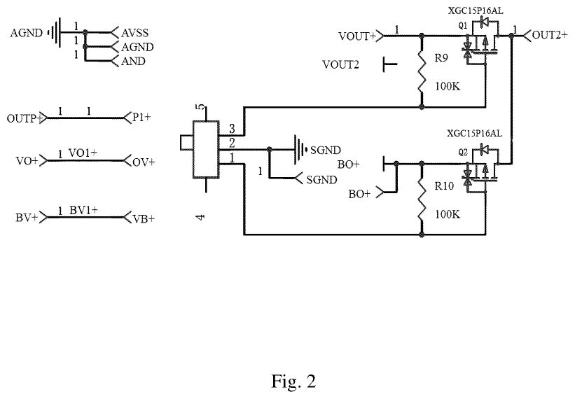

Further elaboration of the present application is provided below in conjunction with the accompanying figures, as shown in FIGS. 1-5. The present application offers a control circuit suitable for power supplies with freely switchable voltages, comprising a first control circuit for freely switching the power supply voltage, a second control circuit and a third control circuit electrically connected to the first control circuit; wherein the second control circuit is a charging circuit, and the third control circuit is a protection circuit.

As shown in FIG. 1, the first control circuit is provided with a toggle switch K1 for controlling real-time switching of the power supply voltage. The third pin of the toggle switch K1 is connected to the first terminal of a ninth resistor R9, the first terminal of a first transistor Q1, and the second control circuit, respectively. The second terminal of the ninth resistor R9 is connected to the output terminal VOUT+ and the second terminal of the first transistor Q1. The third terminal of the first transistor Q1 is connected to the output terminal OUT2+ and the third terminal of a second transistor Q2. In the first control circuit, the resistance value of the ninth resistor R9 is 100K.

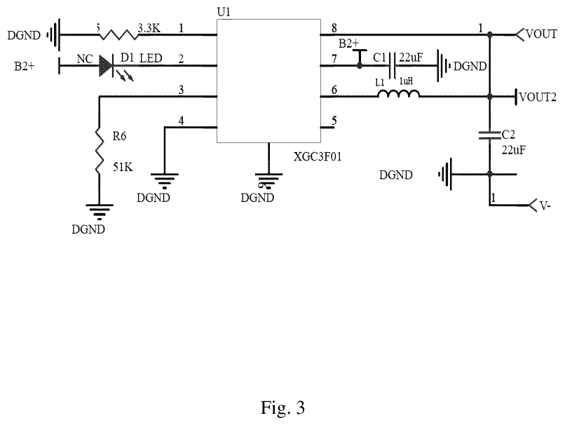

As shown in FIG. 1, the first pin of the toggle switch K1 is connected to the first terminal of a tenth resistor R10 and the first terminal of the second transistor Q2. The second terminal of the tenth resistor R10 is connected to the input terminal BO+ and the second terminal of the second transistor Q2. Both the first transistor Q1 and the second transistor Q2 are XGC15P16AL. In other words, in a specific embodiment of the present application, the first control circuit is provided with a toggle switch K1 for controlling real-time switching of power supply voltage output (1.5V/3.7V). The third pin of the toggle switch K1 is connected to the first terminal of the ninth resistor R9 and the first terminal of the first transistor Q1. The second terminal of the ninth resistor R9 is connected to the sixth pin of a first chip U1 (shown in FIG. 3) via the terminal VOUT2, and the eighth pin of the first chip U1 is connected to the second terminal of the first transistor Q1. The first controlled discharge terminal P1+ is connected to the sixth pin of the first chip U1 via the first terminal of the transistor Q1 and is also connected to the eighth pin of the first chip U1 via the first terminal of the first transistor Q1. The first pin of the toggle switch K1 is connected to the first terminal of the tenth resistor R10 and the first terminal of the second transistor Q2. The second terminal of the tenth resistor R10 is connected to the BO+ output terminal and also to the second terminal of the second transistor Q2. The first controlled discharge terminal P1+ is connected to the BO+ output terminal via the first terminals of the first and second transistors Q2. In the first control circuit, the resistance value of the tenth resistor R10 is 100K.

As shown in FIG. 3, the second control circuit includes a first control chip U1.

The first pin of the first control chip U1 is connected to the first terminal of a fifth resistor R5. The second terminal of the fifth resistor R5 is grounded. The second pin of the first control chip U1 is connected to the cathode of a first light-emitting diode D1, and the anode of the first light-emitting diode D1 is connected to the input terminal B2+. In the second control circuit, the resistance value of the fifth resistor R5 is 3.3K.

The third pin of the first control chip U1 is connected to the first terminal of a sixth resistor R6, and the second terminal of the sixth resistor R6 and the fourth pin of the first control chip U1 are commonly grounded. In the second control circuit, the resistance value of the sixth resistor R6 is 51K.

The sixth pin of the first control chip U1 is connected to the first terminal of a first inductor L1. The second terminal of the first inductor L1 is connected to the output terminal VOUT2, the first terminal of a second capacitor C2, and the eighth pin of the first control chip U1, respectively. The second terminal of the second capacitor C2 is grounded. In the second control circuit, the inductance value of the first inductor L1 is 1 uH, and the capacitance value of the second capacitor C2 is 22 uF.

The seventh pin of the first control chip U1 is connected to the input terminal B2+ and the first terminal of a first capacitor C1, respectively. The second terminal of the first capacitor C1 is grounded. The first control chip U1 is XGC3F01. In the second control circuit, the capacitance value of the first capacitor C1 is 22 uF.

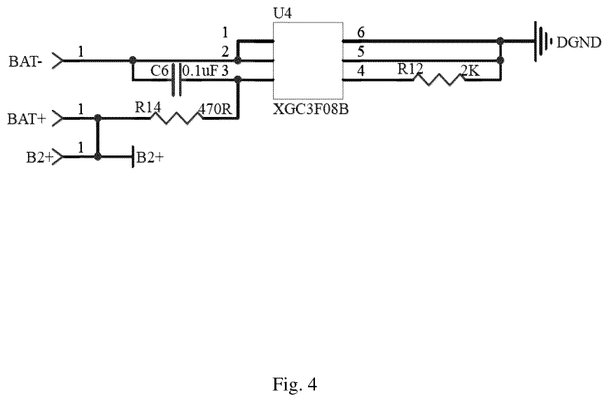

As shown in FIG. 4, the third control circuit includes a fourth control chip U4.

The first pin of the fourth control chip U4 is connected to the second pin of the fourth control chip U4 and the first terminal of a sixth capacitor C6, respectively.

The second terminal of the sixth capacitor C6 is connected to the third pin of the fourth control chip U4 and the first terminal of a fourteenth resistor R14. In the third control circuit, the capacitance value of the sixth capacitor C6 is 0.1 uF.

The fourth pin of the fourth control chip U4 is connected to the first terminal of a twelfth resistor R12. The second terminal of the twelfth resistor R12, the fifth pin of the fourth control chip U4, and the sixth pin of the fourth control chip U4 are commonly grounded. The fourth control chip is XGC3F08B. In the third control circuit, the resistance value of the twelfth resistor R12 is 2K.

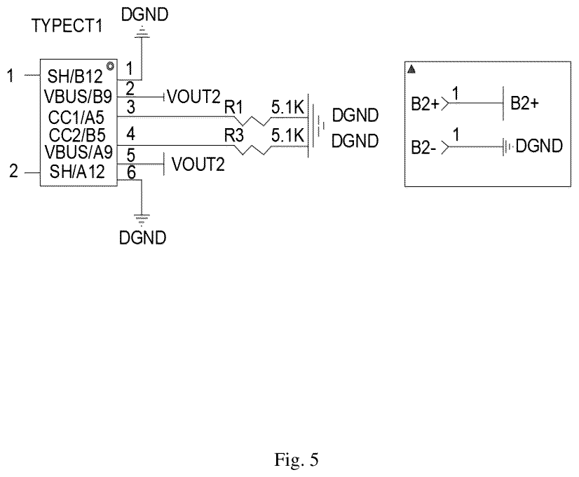

As shown in FIG. 5, preferably, the control circuit applicable to power supplies with freely switchable voltages also includes an interface unit TYPEC1.

The third pin of the interface unit TYPEC1 is connected to the first terminal of a first resistor R1. The fourth pin of the interface unit TYPEC1 is connected to the first terminal of a third resistor R3. The second terminals of the first resistor R1, the third resistor R3, and the first and sixth pins of the interface unit TYPEC1 are commonly grounded. The second and fifth pins of the interface unit TYPEC1 are connected to the first and second control circuits via the terminal VOUT2. The interface unit TYPEC1 is TYPEC6P-LT1. In the interface circuit, the resistance values of the first resistor R1 and the third resistor R3 are both 5.1K.

Specifically, in the embodiment of the present application, the battery protection board includes a toggle switch K1 with two positions. When the toggle switch K1 is in the 1.5V position, the output voltage of the battery is 1.5V (simulating a dry battery voltage output in this state). When the toggle switch is in the 3.7V position, the output voltage of the battery is the standard 3.7V lithium battery voltage, which is consistent with the function of a single lithium battery protection board.

Preferably, in the boost/buck circuits of the present application: to achieve free switching between 1.5V and 3.7V, the circuit needs to include boost circuits (raising 1.5V to 3.7V) and buck circuits (reducing 3.7V to 1.5V). These circuits may consist of inductors, capacitors, diodes, switching devices (such as MOSFETs), and control chips.

This technical solution includes a corresponding battery management chip, which monitors the charging and discharging states of the battery and realizes battery voltage conversion and protection functions. Such chips may have functions such as battery voltage detection, charging current control, discharging current limiting, and overcharge/overdischarge protection.

This technical solution adopts a dual-voltage output design. The battery may adopt a dual-voltage design, with two voltage output terminals inside the battery: one for 1.5V and the other for 3.7V. Users can select the desired voltage output through external circuits or switches.

Furthermore, the present application adopts a hidden metal plate design: in some battery designs, to achieve dual-voltage output, a hidden metal plate design can be used. This design allows the battery to use a 1.5V voltage output during discharging and to be charged using the internal 3.7V voltage during charging.

In principle, when a 1.5V voltage output is required, the battery management chip or external circuit will reduce the 3.7V lithium battery voltage to 1.5V When a 3.7V voltage output is required, it may directly supply power through the battery's internal 3.7V voltage output terminal or raise the 1.5V voltage to 3.7V through a boost circuit (although this is less common because lithium batteries themselves can typically provide a 3.7V voltage).

For example, in wireless mouse modifications, some users convert wireless mouse that originally use 1.5V dry batteries to use 3.7V lithium batteries and use buck chips for voltage conversion, thereby improving the mouse's battery life and operational stability. The modified mouse maintains longer connection stability and no longer disconnects frequently. In remote control upgrades, similar to wireless mouse, some remote controls can also achieve free switching between 1.5V and 3.7V voltages through modifications. This not only improves the remote control distance and response speed of the remote control but also significantly extends its usage time and reduces the frequency of battery replacements.

In summary, the 1.5V and 3.7V freely switchable battery solution addresses technical issues such as voltage conversion efficiency, battery management, and voltage switching mechanisms by employing boost/buck circuits, battery management chips, and dual-voltage output design. It achieves technical effects such as efficient voltage conversion, optimized battery management, user-friendliness, and environmental protection and energy conservation.

That is to say, this application provides a control circuit suitable for power supplies with freely switchable voltages. The control circuit includes a first control circuit for freely switching the power supply voltage, a second control circuit and a third control circuit electrically connected to the first control circuit.

Wherein the second control circuit serves as a charging circuit, and the third control circuit serves as a protection circuit. The first control circuit is provided with a toggle switch K1 for controlling real-time switching of the power supply voltage. The third pin of the toggle switch K1 is connected to the first terminal of a ninth resistor R9, the first terminal of a first transistor Q1, and the second control circuit, respectively. The second terminal of the ninth resistor R9 is connected to the output terminal VOUT+ and the second terminal of the first transistor Q1, respectively, respectively. The third terminal of the first transistor Q1 is connected to the output terminal OUT2+ and the third terminal of a second transistor Q2, respectively. The first pin of the toggle switch K1 is connected to the first terminal of a tenth resistor R10 and the first terminal of the second transistor Q2, respectively. The second terminal of the tenth resistor R10 is connected to the input terminal BO+ and the second terminal of the second transistor Q2, respectively. This allows the power supply voltage to be switchable to output different voltages and realizes battery voltage conversion and protection functions.

In other words, using this application's solution, rapid and efficient voltage conversion between power supply voltages can be achieved to meet the voltage requirements of different devices. In terms of battery management optimization, precise battery management ensures that the battery operates safely and efficiently, extending its service life. In terms of user-friendliness, it provides a simple and easy-to-use voltage switching mechanism, allowing users to easily select the required voltage output as needed. At the same time, in terms of environmental protection and energy conservation, by adopting rechargeable lithium batteries to replace traditional dry batteries, it reduces the pollution of discarded batteries to the environment while achieving energy conservation and reuse.

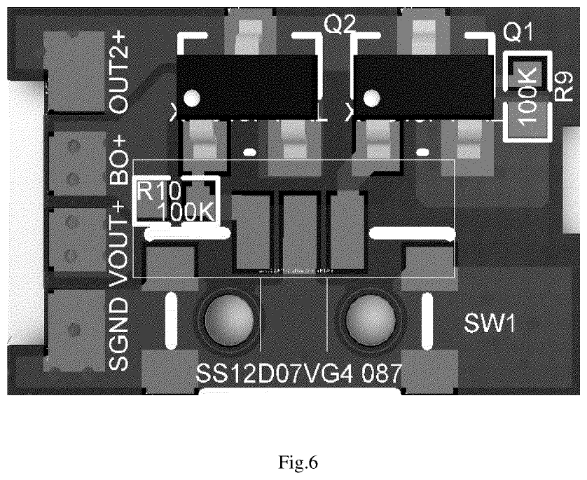

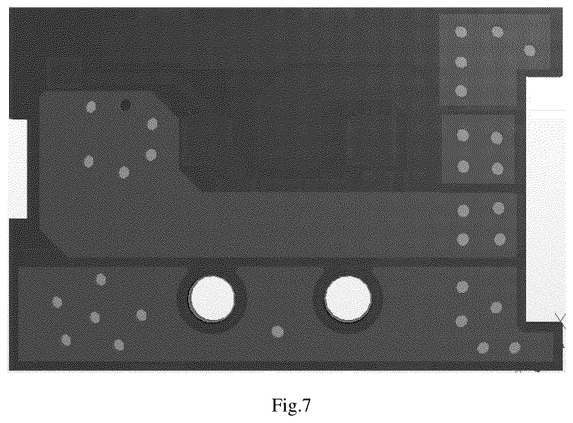

This application also provides a printed circuit board (PCB) with a control circuit suitable for power supplies with freely switchable voltages, as shown in FIGS. 6-9. FIG. 6 is a front view of the PCB of the first control circuit. FIG. 7 is a rear view of the PCB of the first control circuit. As seen in FIG. 6, the PCB of the first control circuit includes a first transistor Q1, a second transistor Q2, a ninth resistor R9, and a tenth resistor R10. The first transistor Q1, second transistor Q2, ninth resistor R9, and tenth resistor R10 are welded to the PCB, making the electronic components stable and reliable, not prone to loosening, and ensuring circuit stability and reliability. The PCB of the first control circuit has two circular positioning holes for fixing the PCB of the first control circuit to the corresponding product structure.

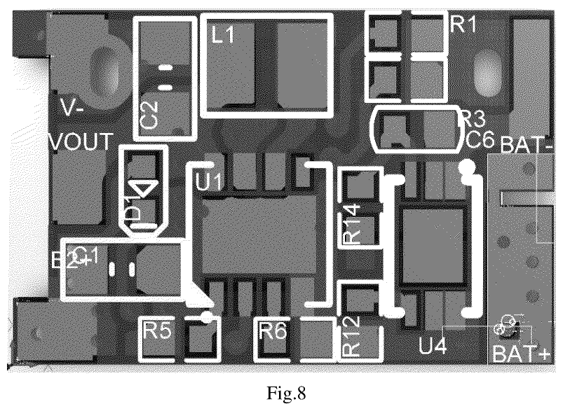

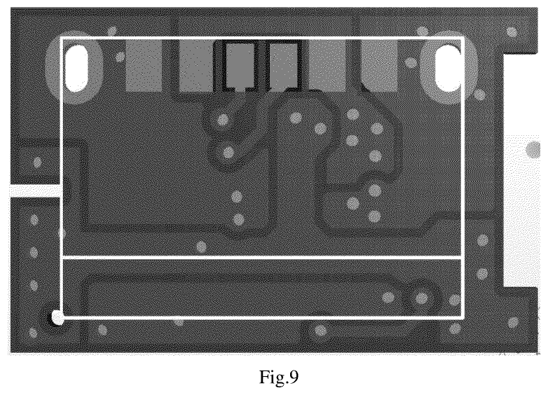

As shown in FIG. 8, FIG. 8 is a front view of the PCB of the second control circuit. FIG. 9 is a rear view of the PCB of the second control circuit. As seen in FIG. 8, the PCB of the second control circuit includes a first chip U1, a fourth chip U2, a first inductor L1, a first resistor R1, a fifth resistor R5, a sixth resistor R6, a twelfth resistor R12, a fourteenth resistor R14, a first capacitor C1, a second capacitor C2, and a sixth capacitor C6. As seen in FIG. 8, the first chip U1, the fourth chip U2, the first inductor L1, the first resistor R1, the fifth resistor R5, the sixth resistor R6, the twelfth resistor R12, the fourteenth resistor R14, the first capacitor C1, the second capacitor C2, and the sixth capacitor C6 are welded to the PCB, making the electronic components stable and reliable, not prone to loosening, and ensuring circuit stability and reliability. The PCB of the second control circuit has two positioning holes for fixing the PCB of the second control circuit to the corresponding product structure.

The embodiments described above merely express several implementations of this application, and the descriptions are relatively specific and detailed, but they cannot be understood as limiting the scope of this application. It should be pointed out that for ordinary technicians in this field, without departing from the premise of this application's concept, several modifications and improvements can still be made, all of which fall within the protection scope of this application. Therefore, the protection scope of this application should be based on the appended claims.

1. A control circuit suitable for a power supply with freely switchable voltage, comprising a first control circuit for freely switching the power supply voltage, a second control circuit and a third control circuit electrically connected to the first control circuit; wherein the second control circuit is a charging circuit, the third control circuit is a protection circuit;
the first control circuit is provided with a toggle switch for controlling real-time switching of the power supply voltage output; the third pin of the toggle switch is connected to first terminal of a ninth resistor, the first terminal of a first transistor, and the second control circuit, respectively; the second terminal of the ninth resistor is connected to the output terminal and the second terminal of the first transistor, respectively; the third terminal of the first transistor is connected to the output terminal and the third terminal of a second transistor, respectively;
the first pin of the toggle switch is connected to the first terminal of a tenth resistor and the first terminal of the second transistor, respectively; the second terminal of the tenth resistor is connected to the input terminal and the second terminal of the second transistor, respectively.

2. The control circuit suitable for a power supply with freely switchable voltage according to claim 1, wherein both the first transistor and the second transistor are XGC15P16AL.

3. The control circuit suitable for a power supply with freely switchable voltage according to claim 1, wherein a first control chip is provided in the second control circuit;
the first pin of the first control chip is connected to the first terminal of a fifth resistor; the second terminal of the fifth resistor is grounded; the second pin of the first control chip is connected to the cathode of a first light-emitting diode; the anode of the first light-emitting diode is connected to the input terminal;
the third pin of the first control chip is connected to the first terminal of a sixth resistor; the second terminal of the sixth resistor and the fourth pin of the first control chip are commonly grounded;
the sixth pin of the first control chip is connected to the first terminal of a first inductor; the second terminal of the first inductor is connected to the output terminal, the first terminal of a second capacitor, and the eighth pin of the first control chip, respectively; the second terminal of the second capacitor is grounded;
the seventh pin of the first control chip is connected to the input terminal and the first terminal of a first capacitor, respectively; the second terminal of the first capacitor is grounded.

4. The control circuit suitable for a power supply with freely switchable voltage according to claim 3, wherein the first control chip is XGC3F01.

5. The control circuit suitable for a power supply with freely switchable voltage according to claim 1, wherein a fourth control chip is provided in the third control circuit;
the first pin of the fourth control chip is connected to the second pin of the fourth control chip and the first terminal of a sixth capacitor, respectively; the second terminal of the sixth capacitor is connected to the third pin of the fourth control chip and the first terminal of a fourteenth resistor, respectively;
the fourth pin of the fourth control chip is connected to the first terminal of a twelfth resistor; the second terminal of the twelfth resistor, the fifth pin of the fourth control chip, and the sixth pin of the fourth control chip are commonly grounded.

6. The control circuit suitable for a power supply with freely switchable voltage according to claim 5, wherein the fourth control chip is XGC3F08B.

7. The control circuit suitable for a power supply with freely switchable voltage according to claim 1, wherein the control circuit is also provided with an interface unit;
the third pin of the interface unit is connected to the first terminal of a first resistor; the fourth pin of the interface unit is connected to the first terminal of a third resistor; the second terminal of the first resistor, the second terminal of the third resistor, the first pin of the interface unit, and the sixth pin of the interface unit are commonly grounded.

8. The control circuit suitable for a power supply with freely switchable voltage according to claim 7, wherein the interface unit is TYPEC6P-LT1.
